(19) United States
(12) Patent Application Publication
(10) Pub. No.: US 2014/0214662 A1
(43) Pub. Date: Jul. 31, 2014

(54) MMIT M-MERCHANT, M-DIASPORA, AND M-CONTENT

(71) Applicant: Babajide Akindele, Worcester, MA (US)

(72) Inventor: Babajide Akindele, Worcester, MA (US)

(21) Appl. No.: 13/749,729

(22) Filed: Jan. 25, 2013

(51) Int. Cl. G06Q 20/38

(52) U.S. Cl. CPC G06Q 20/382
USPC 705/41; 705/44

(57) ABSTRACT

The present invention relates to electronic payment systems for use in paying merchants; for sending money via an electronic medium; and by those wishing to download content from a service such as a gaming or music service. This includes three different services, namely an M-Merchant service, an M-Diaspora service, and an M-Content service.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to electronic payment systems for use in paying merchants; for sending money via an electronic medium; and by those wishing to download content from a service such as a gaming or music service.

### BACKGROUND OF THE INVENTION

It is a problem in the art to provide electronic payment systems for use in paying merchants; for sending money via an electronic medium; and for use by those wishing to download content from a service such as a gaming or music service.

Various prior art systems are known for making payments, sending money, and paying a service for downloading content. Those services require credit cards, debit cards, or in-person cash transfers at money stations to send person-to-person.

There is a need in the art for a mobile wallet, for use in making convenient mobile purchases, cash transfers, and online payment for content downloading services.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an electronic payment systems for use in paying merchants; for sending money via an electronic medium; and for use by those wishing to download content from a service such as a gaming or music service.

The device of the present invention provides a unique invention intended to make life easier. The design makes it possible to provide electronic payment systems for use in paying merchants; for sending money via an electronic medium; and for use by those wishing to download content from a service such as a gaming or music service.

There is a need in the art for a mobile wallet, for use in making convenient mobile purchases, cash transfers, and online payment for content downloading services.

Other objects and advantages of the present invention will be more readily apparent from the following detailed description when read in conjunction with the accompanying drawings.

### BRIEF DESCRIPTION OF THE DRAWINGS

FIG. 1 is schematic flowchart illustrating basic steps for the M-Merchant system.

FIG. 2 is a schematic diagram illustrating work flow for the M-Merchant system.

FIG. 3 is a schematic flowchart illustrating basic steps for the M-Diaspora system.

FIG. 4 is a schematic diagram illustrating work flow for the M-Diaspora system.

FIG. 5 is a schematic diagram illustrating basic steps for the M-Content system.

### DETAILED DESCRIPTION OF THE INVENTION

Preliminarily, it is noted that the business methods of the present invention involve use of at least a computer or electronic computing device, and also uses online information transmission and/or wireless communications such as cell phones and other portable electronic devices.

There are three business method systems shown and described herein. The first is an M-Merchant system, the second is an M-Diaspora system, and the third is a M-Content system. The name MMIT below is a company name, which provides these systems. The first, second, and third systems are described further hereunder.

M-Merchant:

MMIT's “M-Merchant” is a feature in which vouchers bought for value of money to be used for payment of goods at a merchant website, which is processed by the MMIT mobile and web solutions in one country after such voucher PIN is loaded unto the MMIT platform, and the value of the voucher bought by this same person is paid to the merchants account (at the current standard exchange rate) once the consumers have made payment for the item they wanted.

Operationally, the M-Merchant works on the model that people who want to purchase items on websites like www.gap.com, www.macys.com, etc., can now buy a cash voucher and go onto their sites and pick the items they want and pay for it without the headache of having their MasterCard or Visa Card rejected because of the G-IP (Global Internet Protocol) issue.

The MMIT M-Merchant solution serves as a channel that connects individual customers and large business establishments. This solution is centralized and not tied to a particular network operator, switching company or small mobile financial services. This is attests to one of the many edges MMIT has built into its solution portfolio.

M-Diaspora

MMIT's “M-Diaspora” is a feature in which vouchers bought for value of money to be transferred to another person is processed by the MMIT mobile and web solutions in one country after such voucher PIN is loaded into the MMIT platform, and the value of the voucher bought by this same person is cashed out physically in a local equivalent (at the current standard exchange rate) currency in the recipient's home country.

Operationally, the M-Diaspora works on the model that people who want to send money to their family outside the country perform some obligations and afterwards they will be able to make transfers thereafter. The MMIT mobile solution serves as a channel that connects individual customers and large business establishments. The MMIT mobile solution is centralized and not tied to a particular network operator as other small mobile financial services. This is attests to one of the many edges that MMIT has built into its solution portfolio.

M—Content

MMIT also provides

a service, similar in features to those described hereinabove, for use by those wishing to download content from a service such as a gaming or music service.

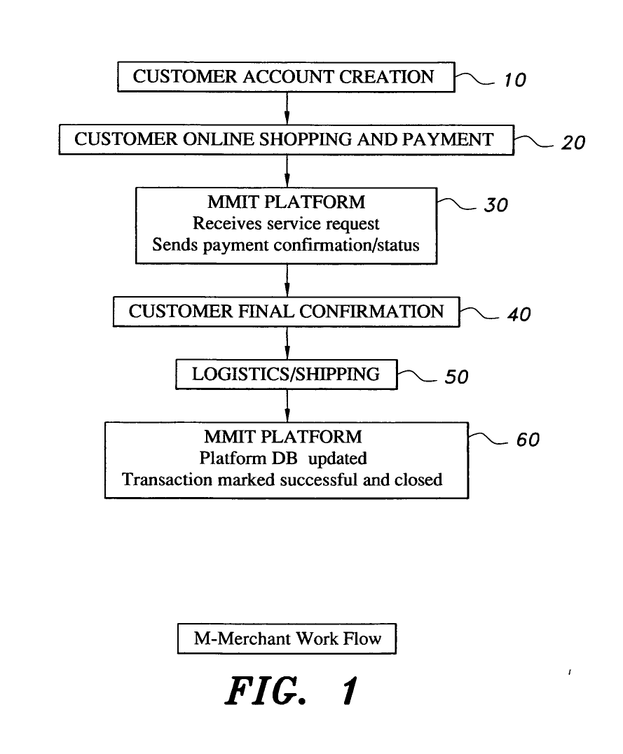

FIG. 1 is schematic flowchart illustrating basic steps for the M-Merchant system. These steps include a customer account creation step 10, a customer online shopping and payment step 20, a step 30 wherein the MMIT platform receives a service request and sends payment confirmation and status, customer final confirmation at step 40, logistics/shipping at step 50, and a step 60 wherein the MMIT platform updates its database, marks the transaction as successful and closed.

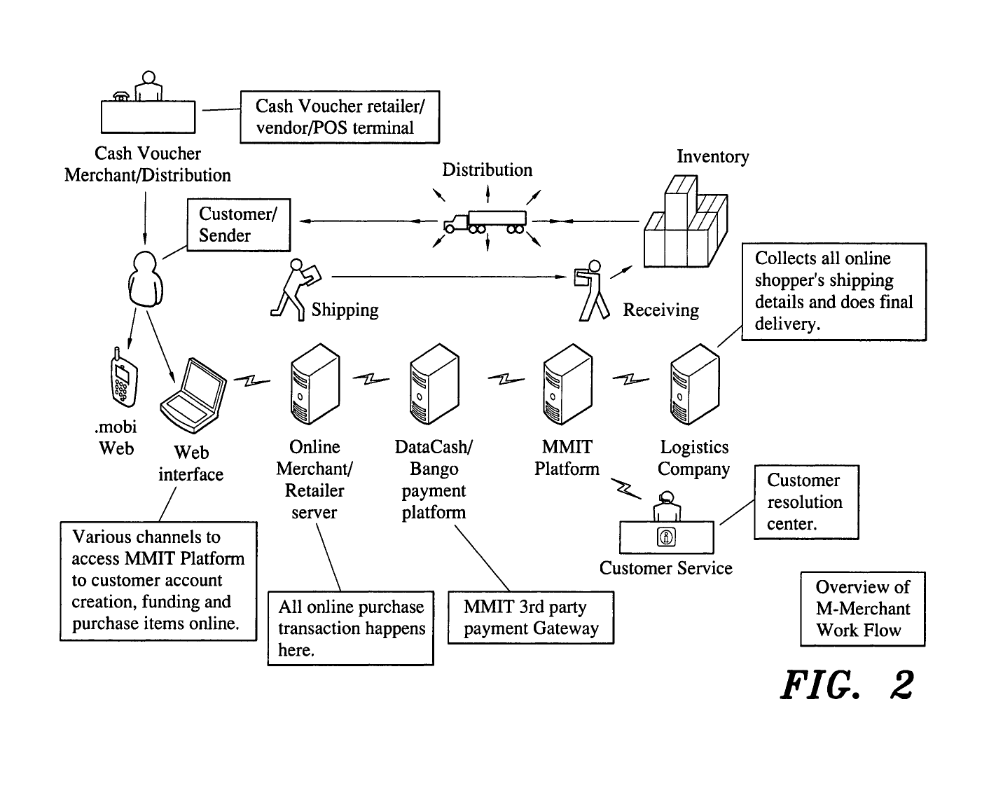

FIG. 2 is a schematic diagram illustrating work flow for the M-Merchant system.

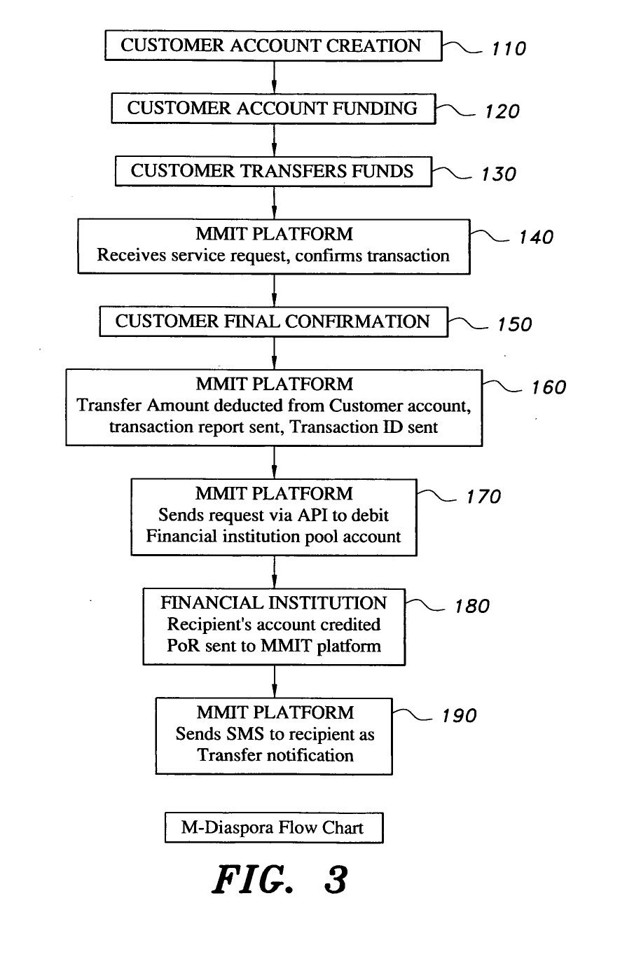

FIG. 3 is a schematic flowchart illustrating basic steps for the M-Diaspora system. These steps include a customer account creation step 110; a customer account funding step 120; a step 130 wherein the customer transfers funds; a step 140 wherein the MMIT platform receives a service request and confirms the transaction; a customer final confirmation step 150; a step 160 wherein the MMIT platform transfers the amount deducted from the customer account, and a transaction report and transaction ID are sent; a step 170 wherein the MMIT platform sends a request via API to debit a financial institution pool account; a step 180 wherein the financial institution credits the recipient's account and PoR is sent to the MMIT platform; and step 190 wherein the MMIT platform sends an SMS to recipient as the transfer notification.

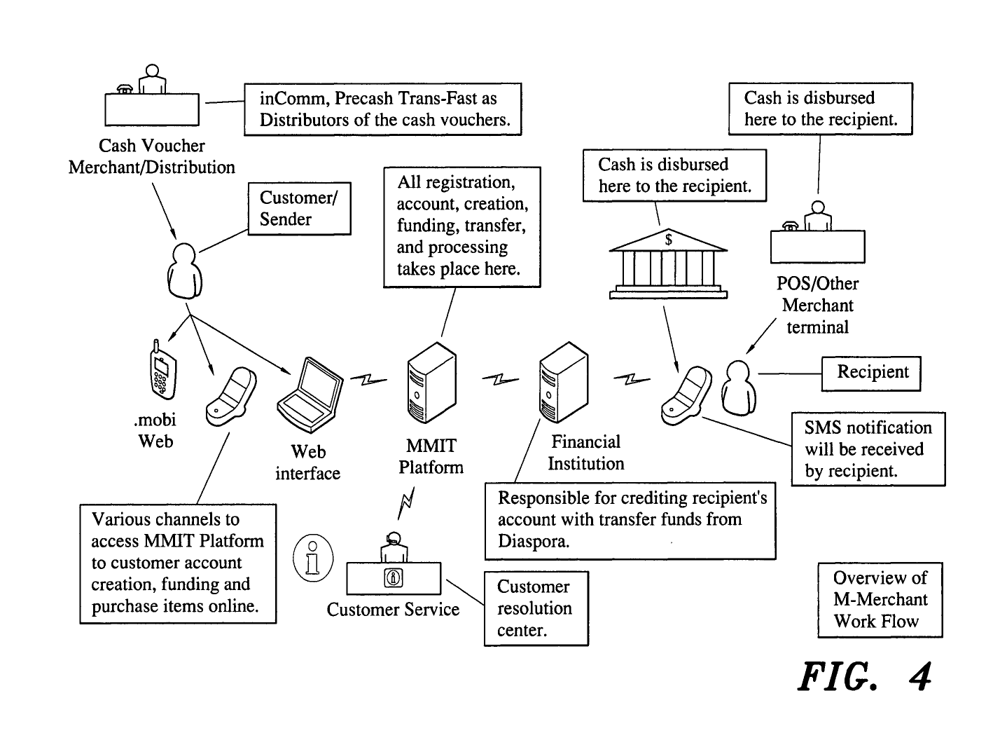

FIG. 4 is a schematic diagram illustrating work flow for the M-Diaspora system.

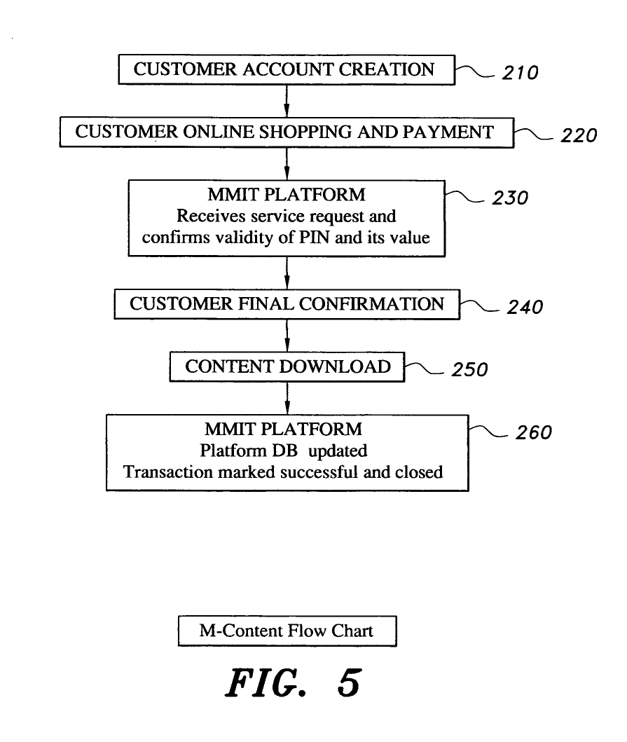

FIG. 5 is a schematic diagram illustrating basic steps for the M-Content system. The system includes a customer account creation step 210; a customer online shopping and payment step 220; a step 230 wherein the MMIT platform receives a service request and confirms the validity of a PIN and its value; a customer final confirmation step 240; a content download step 250; and a step 260 wherein the platform database is updated and the transaction is marked successful and closed.

Details for the described systems are shown in tabular form below, namely for the M-Merchant system, the M-Diaspora system, and the M-Content system.

The above-discussed Tables 1, 2, and 3 are on the following pages.

TABLE 1
M-MERCHANT

| | |
|---|---|
| Description | This is a product targeted at end users within 3^{rd} world |
| | countries, who intend to purchase items online from |
| | reputable and popular retail stores across the globe |
| | e.g. Wal-Mart, Target, GAP, Macy's etc. using |
| | M-Merchant |
| | Cash Vouchers. This service can be accessed via |
| | .mobi/web interface. |
| Actors | M-Merchant Account holder/Customer |
| | MMIT platform |
| | 3rd party payment agent - Datacash and Bango |
| | Logistics/Shipping company - American AirSea Cargo |

Basic Flow - Steps

| Step: | | |
|---|---|---|
| 1 | Customer | Customer sets up an M-Merchant account |
| | Account | through the various access channels provided |
| | Creation | i.e. .mobi/web interface through a mobile or PC. |
| | | The account set up is onetime registration |
| | | which is done by ONLY end users who intend |
| | | to purchase items online from retailers. This |
| | | registration/sign on must be in strict adherence |
| | | with standard KYC process. Intending customers |
| | | must enter: 1st and last name, phone number, |
| | | physical address, email address, etc. |
| | | At this stage an account is successfully created |
| | | by the customer as long as compulsory fields |
| | | are populated accordingly. |
| | | Customer has the liberty to load value unto |
| | | his/her account after purchasing cash voucher |
| | | for future use on any merchant website. |
| 2 | Customer | Customer purchases a Cash Voucher from any |
| | Online | of MMIT voucher vendor/distributor/retailers/POS |
| | Shipping | terminals. Vouchers hold the equivalent of the |
| | and | amount the customer has paid for it. |
| | Payment | Customer goes online, browses through various |
| | | global online retail stores and identifies item(s) |
| | | he/she wants to purchase. |
| | | Upon check-out from the site, customer |
| | | chooses a payment option that best suits his |
| | | ability to pay online. For the sake of this |
| | | product, customer will choose MMIT 3rd party |
| | | payment agent (Datacash-USA or Bango- |
| | | UK) or generates a one-time 12-16 digits pin |
| | | from the M-Merchant section of their mobile |
| | | wallet based on the value that is available in |
| | | their mobile wallet. This function will allow |
| | | other 3rd party mobile wallet aggregators to |
| | | have the M-Merchant pin generator |
| | | embedded into their mobile wallet that will |
| | | allow their consumers to create different |
| | | value pins for transactions. |
| | | Customer loads a 12-16 digits PIN revealed on |
| | | the Cash Voucher purchased unto the payment |
| | | verification page of the merchant/retailers |
| | | website and then waits for verification of |
| | | payment. |
| | | Customer also provides his/her shipping details |
| | | on this page. |
| 3 | MMIT | Receives a service request and processes it in |
| | Platform | order to confirm validity of PIN and its value. |
| | | Payment confirmation/status is sent to the |
| | | customer real-time as a confirmation page |
| | | whilst on the site. |
| 4 | Customer | Payment confirmation returns to the customer |
| | Final | on the payment confirmation page. |
| | Confirmation | Customer is directed to the completion page of |
| | | the merchant/retailer website and details of the |
| | | purchased items, receipt number and shipping |
| | | information are displayed. |
| | | Details of transaction done are received by the |
| | | customer for easy tracking via eMail or SMS |
| 5 | Logistics/ | Once the purchase transaction is completed on |
| | Shipping | the customer level, such orders are automatically |
| | | shipped to MMIT logistics partner |
| | | in the purchasing country by the online |
| | | merchant/retailer. |
| | | The logistics company through its integration |
| | | will have access to the shipping addresses, |
| | | transaction 10 etc of each customer that |
| | | requires his or her goods shipped to their |
| | | respective countries. |
| | | They carry out onward delivery to customers as |
| | | specified in their shipping address. |
| | | All successful deliveries are updated on MMIT |
| | | platform |
| 6 | MMIT | The platform DB is updated and transaction is |
| | Platform | marked successful and closed. |

TABLE 2
M-DIASPORA

| | |
|---|---|
| Description | This is a product targeted at end users in Diaspora who |
| | intend to send money home via an electronic medium. |
| | It is a platform that allows end users to create a virtual |
| | wallet, store virtual cash and allow for virtual transfer of |
| | such funds to families based abroad. This service tan |
| | be accessed via various channels, i.e. J2ME app and |
| | .mobi/web interface. |
| Actors | M-Diaspora Account holder/Customer |
| | MMIT platform |
| | Financial institutions |

Basic Flow - Steps

| Step: | | |
|---|---|---|
| 1 | Customer | Customer sets up an M-Diaspora account |
| | Account | through the various access channels provided |
| | Creation | i.e. J2ME installed in a mobile phone or |
| | | .mobi/web interface through a mobile or PC. |
| | | The account set up is onetime registration |
| | | which is done by ONLY end users in Diaspora. |
| | | This registration must be in strict adherence |
| | | to the format regulated by the country of money |
| | | transfer origin/World Bank. |
| | | At this stage an account is successfully created |
| | | by the customer as long as compulsory fields |
| | | are populated accordingly. |
| 2 | Customer | Customer purchases a Cash Voucher from any |
| | Account | of MMIT voucher vendor/distributor/retailers/POS |
| | Funding | terminals. Vouchers hold the equivalent of the |
| | | amount the customer wants to transfer to a recipient |
| | | in another country. (Customer pays transfer fee on |
| | | the amount he/she will transfer at the vendor/ |
| | | distributor/retailer/POS terminal outlet.) |
| | | Customer loads a 12-16 digits PIN revealed on |
| | | the Cash Voucher purchased unto his/her account. |
| | | A PIN check is performed on the backend |
| | | (MMIT Platform) to confirm value of PIN and |
| | | authenticity. |
| | | Authentic and real value of the PIN is displayed |
| | | on M-Diaspora web page of customer's account |
| | | (This way account is funded and ready to |
| | | perform any transfer within the limits of the |
| | | account value. |
| 3 | Customer | Customer clicks on “M-Diaspora transfer” on |
| | Transfers | .mobi/web interface or launches the J2ME app. |
| | Funds | Customer populates the provided fields which |
| | | will be the transfer details, usually details of the |
| | | recipient. |
| | | Drop down list is provided for customer |
| | | to determine how recipient should be paid out |
| | | in home country, e.g. POS terminal, ATM, Bank |
| | | Account, M-Wallet, etc. |
| 4 | MMIT | Receives a service request and processes it in |
| | Platform | order to confirm validity of account holder, |
| | | confirmation of sufficient funds, correctness/ |
| | | appropriate details of recipient. |
| 5 | Customer | Customer receives an editable re-confirmation/ |
| | Final | summary page with the full details of the transfer |
| | Confirmation | to be initiated, i.e. amount equivalence in |
| | | receiver's currency with the going exchange |
| | | rate indicated, recipient full details. |
| 6 | MMIT | Transfer amount is deducted from customer |
| | Platform | account immediately. |
| | | Transaction report which includes amount sent |
| | | in local denomination and transaction 10 for |
| | | trace purpose is sent to the customer via email |
| | | or SMS. |
| 7 | MMIT | Sends a request via secured API to debit the |
| | Platform | Financial Institution pool account the tune of |
| | | specified amount initiated by the customer in |
| | | Diaspora but in the country's local currency. |
| 8 | Financial | Recipient's account will be credited accordingly |
| | Institution | details provided by the customer in |
| | | Diaspora which is sent by MMIT platform. |
| | | PoR will be sent to MMIT platform upon |
| | | successful crediting of recipient's account. |
| 9 | MMIT | Upon receipt of PoR from the Financial |
| | Platform | Institution, an SMS is sent to the recipient as |
| | | transfer notification. |

TABLE 3
M-CONTENT

| | |
|---|---|
| Description | This is a product targeted at who do not have |
| | access to purchase of gaming top-up content, apps, |
| | music, etc., from the likes of Facebook, EA Sports, |
| | Sony Play Station, X-box, Skype, Blackberry App |
| | Store, i-tunes store, Android market, etc. using mContent |
| | Cash Vouchers. |
| | This service can be accessed via .mobi/web interface. |
| Actors | M-Content Account holder/Customer |
| | MMIT platform |
| | 3rd party payment agent - Datacash and Bango |

Basic Flow - Steps

| Step: | | |
|---|---|---|
| 1 | Customer | Customer sets up an M-Content account |
| | Account | through the various access channels provided |
| | Creation | i.e. .mobi/web interface through a mobile or PC. |
| | | The account set up is onetime registration |
| | | which is done by ONLY end users who intend |
| | | to purchase items online from retailers. This |
| | | registration/sign on must be in strict adherence |
| | | with standard KYC process. Intending customers |
| | | must enter: 1st and last name, phone number, |
| | | physical address, email address, etc. |
| | | At this stage an account is successfully created |
| | | by the customer as long as compulsory fields |
| | | are populated accordingly. |
| | | Customer has the liberty to load value unto |
| | | his/her account after purchasing cash voucher |
| | | for future use on any merchant website. |
| 2 | Customer | Customer purchases a Cash Voucher from any |
| | Online | of MMIT voucher vendor/distributor/retailers/POS |
| | Shipping | terminals. Vouchers hold the equivalent of the |
| | and | amount the customer has paid for it. |
| | Payment | Customer goes online, browses through desired |
| | | global online social network or app stores and |
| | | identifies content (s) he/she wants to purchase. |
| | | Upon check-out from the site, customer |
| | | chooses a payment option that best suits his |
| | | ability to pay online. For the sake of this |
| | | product, customer will choose MMIT 3rd party |
| | | payment agent (Datacash-USA or Bango- |
| | | UK) or generates a one-time 12-16 digits pin |
| | | from the M-Merchant section of their mobile |
| | | wallet based on the value that is available in |
| | | their mobile wallet. This function will allow |
| | | other 3rd party mobile wallet aggregators to |
| | | have the M-Merchant pin generator |
| | | embedded into their mobile wallet that will |
| | | allow their consumers to create different |
| | | value pins for transactions. |
| | | Customer loads a 12-16 digits PIN revealed on |
| | | the Cash Voucher purchased unto the payment |
| | | verification page of the merchant/retailers |
| | | website and then waits for verification of |
| | | payment. |
| | | Customer also provides his/her shipping details |
| | | on this page. |
| 3 | MMIT | Receives a service request and processes it in |
| | Platform | order to confirm validity of PIN and its value. |
| | | Payment confirmation/status is sent to the |
| | | customer real-time as a confirmation page |
| | | whilst on the site. |
| 4 | Customer | Payment confirmation returns to the customer |
| | Final | on the payment confirmation page. |
| | Confirmation | Customer is directed to the completion page of |
| | | the website and details of the purchased items, |
| | | and receipt number. |
| | | Details of transaction done are received by the |
| | | customer for payment confirmation. |
| 5 | Content | Once the purchase transaction is completed on |
| | Download | the customer level, content is downloaded. |
| 6 | MMIT | The platform DB is updated and transaction is |
| | Platform | marked successful and closed. |

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. An electronic payment system for use in paying merchants using a computer and an international communication network (ICN), comprising the steps of:
(a) providing an M-Merchant account program to allow a customer to set up an M-Merchant account and to load value onto said M-Merchant account using the computer and the ICN;
(b) providing an online purchase option for said M-Merchant account program having a selectable payment option to charge said M-Merchant account, whereby a customer doing online shopping can select the M-Merchant account payment option;
(c) providing an MMIT platform for processing service requests including processing to confirm validity of account value and PIN information;
(d) providing payment confirmation upon purchase in step (b) above using the MMIT platform set forth in step (c) above; and
(e) updating shipping information on said MMIT platform.

2. An electronic payment system for sending money via an electronic medium, so as to allow users to create a virtual wallet, store virtual cash, and allow for virtual transfer of funds stored in the virtual wallet to others, using a computer and an international communication network (ICN), comprising the steps of:
(a) providing an M-Diaspora account program to allow a customer to set up an M-Diaspora account and to set up a customer PIN, using the computer and the ICN;
(b) providing a Cash Voucher for purchase by users of said M-Diaspora account program for funding said M-Diaspora account using the computer, whereby a customer can view an account balance of said M-Diaspora account using said customer PIN;
(c) providing an MMIT platform for transferring funds in said M-Diaspora account using the computer and the ICN, using said M-Diaspora account and said customer PIN, and transferee information supplied by the customer;
(d) providing payment confirmation upon transfer of funds in step (d) above using the MMIT platform set forth in step (c) above; and
(e) updating funds transfer information for said M-Diaspora account on said MMIT platform.

3. An electronic payment system for use by those wishing to download content from a service such as a gaming or music service via an electronic medium, so as to allow users to create a virtual wallet, store virtual cash, and allow for virtual transfer of funds stored in the virtual wallet to others, using a computer and an international communication network (ICN), comprising the steps of:
(a) providing an M-Content account program to allow a customer to set up an M-Content account, using the computer and the ICN, to create a virtual wallet;
(b) providing a Cash Voucher for purchase by users of said M-Content account program for funding said M-Content account using the computer;
(c) providing an online purchase option for said M-Content account program having a selectable payment option to charge said M-Content account, whereby a customer doing online shopping for downloadable online content can select the M-Content account payment option;
(d) providing an MMIT platform for processing service requests including processing to confirm validity of virtual wallet account value;
(e) providing payment confirmation upon purchase in step (c) above using the MMIT platform set forth in step (d) above; and
(e) updating transaction information on said MMIT platform to indicate completed purchase.
